(19) United States
(12) Patent Application Publication
(10) Pub. No.: US 2015/0171458 A1
(43) Pub. Date: Jun. 18, 2015

(54) FUEL CELL MODULE, FUEL CELL, MANUFACTURING METHOD OF FUEL CELL MODULE, AND METHOD FOR SUPPLYING OXIDANT TO FUEL CELL MODULE

(71) Applicant: MITSUBISHI HITACHI POWER SYSTEMS, LTD., Yokohama-shi (JP)

(72) Inventors: Koji Miyamoto, Tokyo (JP); Masahiro Mihara, Tokyo (JP); Norihisa Matake, Tokyo (JP); Takeshi Matsuo, Tokyo (JP); Shunsaku Matsumoto, Tokyo (JP); Katsuaki Inoue, Nagasaki (JP); Masaki Yasunaga, Nagasaki (JP); Tomonori Souda, Nagasaki (JP)

(73) Assignee: MITSUBISHI HITACHI POWER SYSTEMS, LTD., Yokohama-shi (JP)

(21) Appl. No.: 14/571,877

(22) Filed: Dec. 16, 2014

(30) Foreign Application Priority Data
Dec. 18, 2013 (JP) 2013-261607
Feb. 28, 2014 (JP) 2014-039903

(51) Int. Cl. H01M 8/24; H01M 8/02; H01M 8/04

(52) U.S. Cl. CPC H01M 8/2465; H01M 8/04201; H01M 8/243; H01M 8/0271

(57) ABSTRACT

The present invention provides a fuel cell module capable of properly supporting many cell stacks. A plurality of thin plate holes (21-1 to 21-n), through which a plurality of cell stacks (5-1 to 5-n) respectively penetrate, are formed in a tube plate (2) supporting the plurality of cell stacks (5-1 to 5-n). The tube plate (2) is formed of a plurality of thin plate portions (22-1 to 22-n) forming the plurality of thin plate holes (21-1 to 21-n) and a thick plate portion (23) disposed surrounding the plurality of thin plate portions (22-1 to 22-n) and having a larger plate thickness than the plurality of thin plate portions (22-1 to 22-n). Such a tube plate (2) is less likely to deform compared with other tube plates having a generally uniform plate thickness.

### TECHNICAL FIELD

The present invention relates to a fuel cell module, a fuel cell, a manufacturing method of a fuel cell module, and a method for supplying an oxidant to a fuel cell module.

### BACKGROUND ART

A fuel cell is a power generation device that uses a method of power generation through an electrochemical reaction, and has features such as excellent power generation efficiency and environmental compatibility. Therefore, research and development are underway to put the fuel cell into practical use as an urban energy supply system for the 21st century.

The fuel cell is composed of a fuel electrode being a fuel-side electrode, an air electrode being an air (oxidant)-side electrode, and an electrolyte between the fuel electrode and the air electrode that allows only ions to pass through, and various forms of fuel cells according to the type of electrolyte have been developed.

A solid oxide fuel cell (hereinafter called an SOFC) uses ceramics such as zirconia ceramics as the electrolyte, and operates on fuels such as city gas, natural gas, petroleum, methanol, and coal-gasified gas. The SOFC operates at temperatures as high as about 700 to 1000° C. to increase the ionic conductivity, and it is known as a versatile and highly efficient high temperature-type fuel cell.

Known SOFCs include those equipped with a plurality of cylindrical cell stacks in which fuel cell cells are formed on the surface of porous substrate tubes. The plurality of cell stacks are supported by being respectively inserted into a plurality of holes formed in a flat tube plate (see PTLs 1 to 4).

FIG. 5 shows a conventional example of an upper tube plate. An upper tube plate 100 of the conventional example is formed of a thin plate portion 101 and a frame 102. The thin plate portion 101 has a plate-like shape, and a plurality of through-holes 103-1 to 103-n, into which a plurality of cell stacks are respectively inserted, are formed in the thin plate portion 101. The frame 102 is formed on the side edges of the thin plate portion 101.

As shown in FIG. 6, a plate-like member 104 and a plate-like member 105 of the frame 102 sandwich the side edges of the thin plate portion 101, and the plate-like member 104 and the plate-like member 105 are welded on the thin plate portion 101.

The method disclosed in PTL 5 is cited as an example of known methods for supplying air to a fuel cell that are applicable to fuel cells.

### CITATION LIST

### Patent Literature

{PTL 1}

The Publication of Japanese Patent No. 3727906

{PTL 2}

The Publication of Japanese Patent No. 4043457

{PTL 3}

The Publication of Japanese Patent No. 4848177

{PTL 4}

The Publication of Japanese Patent No. 4908761

{PTL 5}

Japanese Unexamined Patent Application, Publication No. 2013-171676

### SUMMARY OF INVENTION

### Technical Problem

It is desirable in a solid oxide fuel cell to integrate a larger number of cell stacks inside a power generation chamber in order to improve the power generation efficiency without causing an increase in installed capacity and installation area. For this purpose, it is necessary to secure the strength for supporting the larger number of cell stacks. It is also necessary to supply a fuel gas on the fuel electrode-side and air (oxidant) on the air electrode-side separately and to adopt a structure suitable for maintenance.

As shown in FIG. 16, a fuel cell (fuel cell module) 10 disclosed in PTL 5 includes: a casing (container) 9 of heat insulating material; a plurality of fuel cell stacks 5 having a substantially cylindrical shape; upper and lower tube plates 2, 3 supporting the cell stacks 5 at both ends; upper and lower heat insulators 16, 17 disposed between the upper and lower tube plates 2, 3; and a support stand 30 having a double-container structure that is provided in a lower part of the casing 9 and houses a fuel discharge header (first space) 7 while forming an air passage (an air supply passage 40 and an air circulation hole 41 to be described later).

In order to form an air discharge header 28 to be described later, the upper heat insulator 16 is halved into a first upper heat insulator 16A and a second upper heat insulator 16B. That is, the air discharge header 28 is formed between the first upper heat insulator 16A and the second upper heat insulator 16B.

A power generation chamber 8 is formed between the casing 9 and the upper and lower heat insulators 16, 17, more particularly, between the first upper heat insulator 16A and the lower heat insulator 17. A fuel supply header 6 is formed above the upper tube plate 2, and a fuel supply pipe 11 is connected on the upper surface of the fuel supply header 6. The fuel discharge header 7 is formed under the lower tube plate 3.

An air supply header 27 is formed between the lower tube plate 3 and the lower heat insulator 17. The reference sign 15 in the drawing denotes an air discharge pipe connected with the air discharge header 28.

The upper tube plate 2 is a plate-like member disposed on the upper side (upside in FIG. 16) in the longitudinal direction of the rectangular columnar casing 9 that is substantially rectangular in horizontal cross-section, and serves as a lower surface member of the fuel supply header 6.

Similarly, the lower tube plate 3 is a plate-like member disposed on the lower side (downside in FIG. 16) in the longitudinal direction, and serves as an upper surface member of the fuel discharge header 7 and as a lower surface member of the air supply header 27. In addition, the lower tube plate 3 is a member which seals the upper end of the air supply passage 40 to be described later and of which the outer peripheral part functions as a collar portion 7a.

On the lower tube plate 3, one ends of the cell stacks 5 are fixed and supported airtightly. A fuel gas flows along the inner surface of the cell stacks 5 and thereby circulates via the power generation chamber from the fuel supply header 6 to the fuel discharge header 7.

The term longitudinal direction in this case can be substituted with the vertical direction of the casing 9 that has a substantially rectangular columnar shape.

The cell stack 5 is a substantially cylindrical tube formed of porous ceramics, and is provided with fuel cell cells (not shown) that generate power in an intermediate region in the longitudinal direction.

The cell stacks 5 are supported by through-holes bored in the upper and lower tube plates 2, 3 such that one open ends of the cell stacks 5 open in the fuel supply header 6 and the other open ends open inside the fuel discharge header 7. The cell stacks 5 are disposed such that the fuel cell cells are positioned only inside the power generation chamber 8.

The upper heat insulator 16 is disposed on the upper side (upside in FIG. 16) in the longitudinal direction of the casing 9, and is a member formed of a heat insulating material into the shape of a blanket, a board, or the like. The lower heat insulator 17 is disposed on the lower side (downside in FIG. 16) in the longitudinal direction of the casing 9, and is a member formed of a heat insulating material into the shape of a blanket or, a board, or the like, and serves also as the upper surface member of the air supply header 27.

Holes 16a, 17a through which the cell stacks 5 are inserted are formed in the upper heat insulator 16 and the lower heat insulator 17, and the diameters of the holes 16a, 17a are larger than the diameter of the cell stack 5 in order to allow air circulation.

In such a configuration, the heat of the lower heat insulator 17 is more likely to be transferred to the air flowing into the power generation chamber 8 through the gap between the cell stacks 5 and the holes 17a, which helps keep the temperature of the power generation chamber 8 at a high temperature.

The lower end side (lower structure) of the casing 9 forms an air passage while housing the fuel discharge header 7 inside the support stand 30. The lower structure of the casing 9 is a double-box (double-walled) structure formed of a metal member.

The fuel discharge header 7 is a hollow box-shaped (substantially rectangular parallelepiped) member having the lower tube plate 3 as the upper surface. The fuel discharge header 7 is housed and installed in an internal space (of a substantially rectangular parallelepiped shape) of the support stand 30 that has the substantially same shape as the fuel discharge header 7 and has an open upper surface.

That is, the fuel discharge header 7 is a hollow member having a shape that is substantially the same as that of the support stand 30 but slightly smaller in size. The lower tube plate 3 is mounted on the fuel discharge header 7 by being fixed at an appropriate position such as at the upper end so as to cover the opening of the upper surface of the fuel discharge header 7.

In this case, as the planar shape of the lower tube plate 3 is larger than that of the fuel discharge header 7, the outer peripheral part of the lower tube plate 3 protrudes outward in the horizontal direction along the entire periphery. This protruding part forms a collar portion 7a of the fuel discharge header 7. The reference sign 12 in FIG. 16 denotes a fuel discharge pipe connected on the lower surface of the fuel discharge header 7.

Next, the air supply header 27, the air supply passage (second space) 40, and the fuel discharge header 7 disposed under the power generation chamber 8 shown in FIG. 16 will be described in more detail using FIG. 17 to FIG. 19.

The support stand 30 is a box-shaped member with an open upper surface, and is composed of a side surface 36 and a bottom surface 37. A side wall collar portion 36a is formed at the upper end of the side surface 36. The side wall collar portion 36a is provided with a step portion 33, which is recessed from the outer peripheral side, along the entire periphery. This step portion 33 is a portion on which the collar portion 7a provided in the outer peripheral part at the upper end of the fuel discharge header 7 is installed and engaged when the fuel discharge header 7 is housed in the support stand 30.

An air supply port 39 is provided in a bottom surface 37 of the support stand 30, and an air supply nozzle 35 directed downward is connected with the air supply port 39. An air supply pipe 14 is connected on the side surface of the air supply nozzle 35. The above-described fuel discharge pipe 12 of the fuel discharge header 7 is inserted into the air supply port 39 and the air supply nozzle 35, and penetrates a bottom part 35a of the air supply nozzle 35 downward. The fuel discharge pipe 12 is connected with an external device (not shown).

The air supply port 39 and the air supply nozzle 35 have a larger diameter than the fuel discharge pipe 12. Thus, an air introduction space 42 is formed (see FIG. 17) between the outer peripheral surface of the fuel discharge pipe 12 and the inner peripheral surface of the air supply nozzle 35. The air introduction space 42 guides the air supplied from the air supply pipe 14 to the air supply header 27. The air introduction space 42 has a ring shape in cross-section. The air introduction space 42 communicates with the air supply passage 40, which is a clearance formed between the inner peripheral surface of the support stand 30 and the outer peripheral surface of the fuel discharge header 7, through the air supply port 39. Therefore, the air supplied from the air supply pipe 14 flows from the air introduction space 42 into the air supply passage 40 formed in the outer periphery (bottom surface and side surface) of the fuel discharge header 7.

The side wall collar portion 36a is provided at the upper end of the side wall 36 in the support stand 30. The side wall collar portion 36a includes a plurality of air circulation holes (oxidant circulation passages) 41 provided in the step portion 33 of the side wall collar portion 36a. Since the above-described collar portion 7a is installed on the upper surface of the step portion 33, the air supplied from the air supply passage 40 to the air supply header 27 circulates through the air circulation holes 41. As shown in FIG. 19, the air circulation holes 41 are provided so as to open to the surrounding part of the air supply header 27 in the support stand 30 that is substantially rectangular in a plan view. The air supply passage 40 communicates with the power generation chamber 8 through the air circulation holes 41, and the air is supplied to the power generation chamber 8 via the air supply header 27.

The air circulation hole 41 is formed of a slit 41a in the shape of a recessed groove provided in the step portion 33 and the wall surface of the collar portion 7a.

The fuel cell module 10 introduces a fuel gas from the fuel supply header 6 to the inside of the cell stacks 5 and discharges the fuel gas to the fuel discharge header 7, and at the same time introduces air from the air supply header 27 into the power generation chamber 8 and circulates the air from the downside to the upside along the outer side of the cell stacks 5 toward the air discharge header 28, thereby causing an electrochemical reaction between the fuel gas and the oxidant air to generate power.

As shown in FIG. 20, the outer peripheral end of the collar portion 7a of the lower tube plate 3 and the inner peripheral end of the side wall collar portion 36a of the support stand 30 are joined by welding entirely in the circumferential direction (except for the portions where the slits 41a are formed). Therefore, the collar portion 7a of the lower tube plate 3 and the side wall collar portion 36a of the support stand 30 are deformed by heat during welding. As the collar portion 7a is placed on the step portion 33 in surface contact, when the collar portion 7a of the lower tube plate 3 is deformed and warped by heat during welding in the preceding step, non-uniform contact occurs at positions in the surface contact part. The reference sign 47 in FIG. 20 denotes a welded part.

As a result, a variation in cross-sectional area occurs among the slits 41a or clearance is left at the positions of non-uniform contact, which leads to unbalanced flow of the air passing through the slits 41a. This may affect the temperature or the power generation performance of the power generation chamber 8.

If the lower part of the power generation chamber 8 has a double structure, it is necessary during the assembly to weld the current collector rod and the fuel discharge pipe 12 that are passed through both the fuel discharge header 7 and the support stand 30. However, the welding work is inefficient, and poor welding may result in loss of airtightness.

The present invention has been made in view of these circumstances, and an object of the present invention is to provide a fuel cell module for properly supporting a plurality of cell stacks integrated inside a power generation chamber, a fuel cell, and a manufacturing method of a fuel cell module.

The present invention has been made in view of these circumstances, and another object of the present invention is to provide a fuel cell module capable of uniformizing air supplied into a power generation chamber in the circumferential direction, a fuel cell, and a method for supplying an oxidant to a fuel cell.

### Solution to Problem

A fuel cell module according to a first aspect of the present invention includes a plurality of cell stacks that generate power by causing an electrochemical reaction between a fuel gas and an oxidant gas, and a tube plate supporting the plurality of cell stacks, wherein: the tube plate is composed of thin plate portions and a thick plate portion; a plurality of thick plate holes, which are blind holes where the thin plate portions are remained, are formed in the thick plate portion, and a plurality of thin plate holes, through which the cell stacks penetrate, which are sealed so as to secure airtightness and which have a smaller diameter than the thick plate holes, are formed in the thin plate portions which are respectively remained in the thick plate holes; and the plate thickness of the thick plate portion is larger than the plate thickness of the plurality of thin plate portions.

Compared with the conventional tube plate, the tube plate having such a configuration has increased strength and can suppress deformation. According to the fuel cell module of the present invention, since the plurality of cell stacks are supported by the tube plate, of which only the hole portions where the cell stacks penetrate are composed of the thin plate while other portions are composed of the thick plate, the plurality of cell stacks can be properly supported and a larger number of cell stacks can be properly supported compared with other fuel cell modules which support a plurality of cell stacks by means of the conventional tube plate. The thick plate hole is larger in diameter than the thin plate hole, and the inner peripheral wall of the thick plate hole is formed at a predetermined interval from the inner peripheral wall of the thin plate hole, and for example, the thick plate hole and the thin plate hole are concentric with each other.

In the first aspect, the tube plate is formed by joining together a thin plate and a thick plate, and the plurality of thin plate portions are formed of the thin plate, while the thick plate portions are formed of the thin plate and the thick plate.

Such a tube plate can eliminate the work for forming the thin plate portions by cutting them out of a thick plate, and the tube plate having heat resistance and strength can be produced. At the positions in the thin plate portions where the cell stacks penetrate and are supported, the tube plate has a smoothly curved surface and supports the cell stacks. Using the tube plate having heat resistance and strength, such a fuel cell module can increase the number of cell stacks to support, and the fuel cell module can be made compact by increasing the output per unit area.

In the first aspect, the material forming the thin plate is a metal material of which the difference in thermal expansion coefficient from the material forming the thick plate is within a predetermined range and which is different in material properties from the material forming the thick plate.

Since the thin plate and the thick plate are formed of different materials, such a tube plate can be formed so as to have proper attributes (strength, bending rigidity, heat resistance) compared with the conventional tube plate, of which the thin plate and the thick plate are formed from one and the same material.

A fuel cell according to a second aspect of the present invention is equipped with the fuel cell module of the first aspect.

A manufacturing method of a fuel cell module according to a third aspect of the present invention is a method for producing the fuel cell module of the first aspect, and the method includes producing the tube plate by joining together the thin plate and the thick plate by means of diffusion welding, and supporting the plurality of cell stacks using the tube plate.

Since the thin plate and the thick plate are diffusion-welded, such a tube plate can be properly produced with the thin plate and the thick plate firmly joined together. In the fuel cell module produced by such a manufacturing method of a fuel cell module, since the thin plate and the thick plate are firmly joined together, a defect of the thin plate and the thick plate peeling off from each other is less likely to occur even when heat treatment such as re-welding is performed during maintenance, and the tube plate can be easily mounted and dismounted.

A fuel cell module according to a fourth aspect of the present invention is the fuel cell module of the first aspect equipped with an oxidant supply header including: an oxidant duct having a frame structure; an oxidant supply pipe that is connected on the outer surface of the oxidant duct and supplies an oxidant to the oxidant duct; a plurality of holes that are formed in the oxidant duct and communicate with a space surrounded by the inner surface of the oxidant duct; and a partition surface installed opposite to the surface of the oxidant duct in which the holes are formed.

According to this configuration, the oxidant duct is provided in a frame structure and the oxidant supply pipe is connected on the outer surface of the oxidant duct, and the space formed inside the oxidant duct and the oxidant duct communicate with each other through the plurality of holes.

Since the pressure loss of the oxidant is determined by the shape (dimension) of the holes formed in the oxidant duct, air can be supplied uniformly into the space surrounded by the inner surface of the oxidant duct.

The air blown out from the holes collides against the partition surface and then flows toward the space formed inside the air duct. That is, the air is diffused in all directions on colliding against the partition surface and then flows toward the space formed inside the air duct. In this way, the air supplied through the plurality of holes into the power generation chamber can be further uniformized in the circumferential direction.

Moreover, since the oxidant supply pipe is connected on the outer surface of the oxidant duct, unlike the conventional example, the fuel cell module has no double structure. Thus, the penetration structure of the current collector rod and the fuel discharge pipe is eliminated and the welding work is not required.

In the fourth aspect, the holes may be provided so as to be concentrated at four corners of the oxidant duct, the oxidant duct being rectangular, and less concentrated toward the center in the long-side direction of the oxidant duct.

According to this configuration, it is possible to optimize the uniformization in the circumferential direction of the air supplied into the power generation chamber through the plurality of holes.

A fuel cell according to a fifth aspect of the present invention is equipped with the fuel cell module of the fourth aspect.

According to this configuration, since the fuel cell is equipped with the fuel cell module that can uniformize the air supplied through the plurality of holes into the power generation chamber in the circumferential direction, the power generation performance and the reliability of the fuel cell can be improved.

In the fifth aspect, a heat insulating material may be provided between the oxidant supply header and a fuel discharge header positioned under the oxidant supply header.

According to this configuration, it is possible to improve the heat-retaining property of the power generation chamber and to further improve the power generation performance and the reliability of the fuel cell.

A method for supplying an oxidant to a fuel cell module according to a sixth aspect of the present invention is a method for supplying an oxidant to a fuel cell module, the fuel cell module including: an oxidant duct having a frame structure; an oxidant supply pipe that is connected on the outer surface of the oxidant duct and supplies an oxidant to the oxidant duct; a plurality of holes that are formed in the oxidant duct and communicate with a space surrounded by the inner surface of the oxidant duct; and a partition surface installed opposite to the surface of the oxidant duct in which the holes are formed, wherein the oxidant blown out from the holes collides against the partition surface and then flows toward the space surrounded by the inner surface of the oxidant duct.

### Advantageous Effects of Invention

According to the present invention, it is possible to firmly support the plurality of cell stacks.

According to the present invention, it is possible to uniformize the air supplied into the power generation chamber in the circumferential direction.

### BRIEF DESCRIPTION OF DRAWINGS

{FIG. 1}

FIG. 1 is a cross-sectional view showing a fuel cell module.

{FIG. 2}

FIG. 2 is a plan view showing a tube plate of a fuel cell module according to a first embodiment of the present invention.

{FIG. 3}

FIG. 3 is a cross-sectional view showing the tube plate of the fuel cell module according to the first embodiment of the present invention.

{FIG. 4}

FIG. 4 is a perspective view showing a part of the tube plate of the fuel cell module according to the first embodiment of the present invention.

{FIG. 5}

FIG. 5 is a plan view showing a tube plate of a comparative example.

{FIG. 6}

FIG. 6 is a cross-sectional view showing the tube plate of the comparative example.

{FIG. 7(a)}

FIG. 7(a) is a plan view of an air supply header of a fuel cell module according to a second embodiment of the present invention.

{FIG. 7(b)}

FIG. 7(b) is a cross-sectional view along the line A-A of FIG. 7(a).

{FIG. 7(c)}

FIG. 7(c) is a cross-sectional view along the line B-B of FIG. 7(a).

{FIG. 8}

FIG. 8 is an enlarged view of the circle A indicated by the two-dot chain line in FIG. 7(b).

{FIG. 9}

FIG. 9 is an enlarged view of the circle B indicated by the two-dot chain line in FIG. 7(c).

{FIG. 10}

FIG. 10 is an enlarged cross-sectional view showing the major part of a fuel cell module equipped with an air supply header of a fuel cell module according to a second embodiment of the present invention.

{FIG. 11}

FIG. 11 is an enlarged perspective view showing a part of the air supply header of the fuel cell module according to the second embodiment of the present invention.

{FIG. 12}

FIG. 12 is a plan view of an air discharge header of the fuel cell module shown in FIG. 12 and an air discharge header of the fuel cell module that has been described using FIG. 16.

{FIG. 13}

FIG. 13 is a cross-sectional view along the line C-C of FIG. 12.

{FIG. 14}

FIG. 14 is a cross-sectional view of an air supply header of a fuel cell module according to a third embodiment of the present invention and is a view corresponding to FIG. 9.

{FIG. 15}

FIG. 15 is a cross-sectional view of an air supply header of a fuel cell module according to a fourth embodiment of the present invention and is a view corresponding to FIG. 9.

{FIG. 16}

FIG. 16 is a longitudinal cross-sectional view showing the outline of a conventional fuel cell module.

{FIG. 17}

FIG. 17 is an enlarged view of the lower structure of the fuel cell module shown in FIG. 16 and is a cross-sectional view of a portion including clearances that serve as an oxidant supply passage.

{FIG. 18}

FIG. 18 is an enlarged view of the lower structure of the fuel cell module shown in FIG. 16 and is a cross-sectional view of a portion not including the clearances that serve as an oxidant supply passage.

{FIG. 19}

FIG. 19 is a perspective view showing an enlarged cross-section of the major part related to the lower structure of the fuel cell module shown in FIG. 16.

{FIG. 20}

FIG. 20 is a partially enlarged cross-sectional view showing the lower structure of the fuel cell module shown in FIG. 18.

{FIG. 21}

FIG. 21 is a cross-sectional view showing a modified example of the tube plate of the fuel cell module according to the first embodiment of the present invention.

### DESCRIPTION OF EMBODIMENTS

### First Embodiment

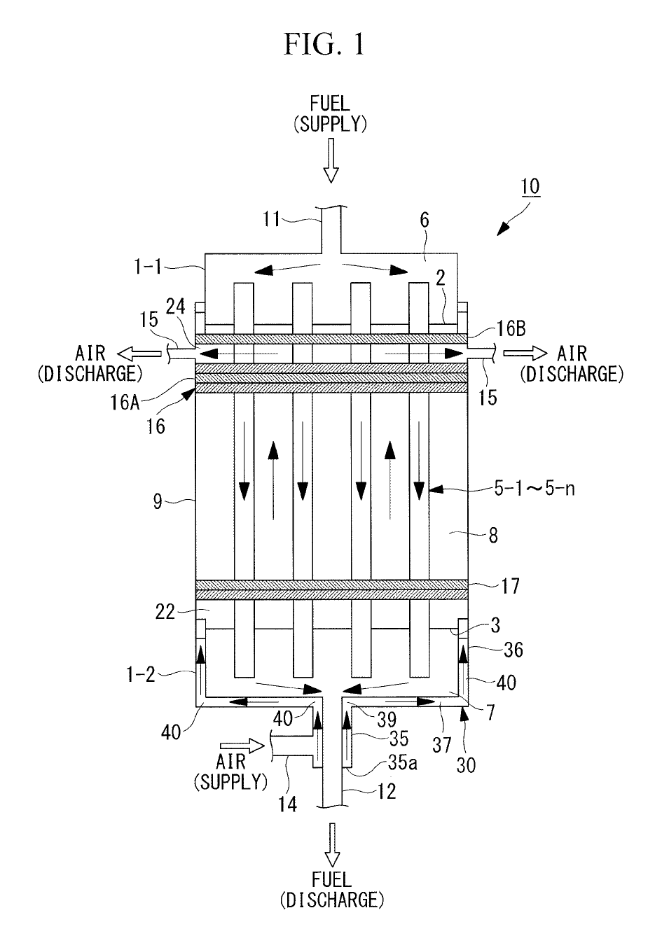

As a first embodiment of the present invention, the configuration of a fuel cell module will be described. In the following description, air will be taken as one example of the oxidant supplied to the fuel cell module, but other oxidants may be used for the present invention. As shown in FIG. 1, a fuel cell module 10 includes an upper lid 1-1, a lower lid 1-2, an upper tube plate 2, a lower tube plate 3, and a plurality of cell stacks 5-1 to 5-n (n=2, 3, 4, . . . , where n is a natural number larger than one). A fuel supply header 6 is formed of the upper lid 1-1 and the upper tube plate 2. A fuel discharge header 7 is formed of the lower lid 1-2 and the lower tube plate 3. A power generation chamber 8 sandwiched between the fuel supply header 6 and the fuel discharge header 7 is a power generation portion of the plurality of cell stacks 5-1 to 5-n, and includes an air supply pipe 14 and an air discharge pipe 15.

The fuel supply header 6 and the fuel discharge header 7 are formed so as to secure airtightness against the power generation chamber 8. A fuel gas flows from the fuel supply header 6 to the fuel discharge header 7 through the plurality of cell stacks 5-1 to 5-n that are fixed on the upper tube plate 2 and the lower tube plate 3. The plurality of cell stacks 5-1 to 5-n are held so as to secure high airtightness (sealing property) against the upper tube plate 2 and the lower tube plate 3 so that the fuel gas does not leak into the power generation chamber 8. At the same time, the air supplied to the power generation chamber 8 is prevented from leaking into the fuel supply header 6 and the fuel discharge header 7. That is, the plurality of cell stacks 5-1 to 5-n are fixed on the upper tube plate 2 and the lower tube plate 3 so that the fuel supply header 6 and the fuel discharge header 7 secure airtightness against the power generation chamber 8.

The upper tube plate 2 has a plate-like shape. The upper tube plate 2 is disposed on top of the power generation chamber 8 so as to separate the fuel supply header 6 and the power generation chamber 8 from each other. The upper tube plate 2 is airtightly fixed by welding etc. on the upper lid 1-1 at the peripheral edges. The lower tube plate 3 has a plate-like shape. The lower tube plate 3 is disposed under the power generation chamber 8 so as to separate the fuel discharge header 7 and the power generation chamber 8 from each other. The lower tube plate 3 is airtightly fixed by welding etc. on the lower lid 1-2 at the peripheral edges.

Each of the plurality of cell stacks 5-1 to 5-n has a power generation element of a solid oxide fuel cell (SOFC) on the surface of a cylindrical substrate, and has a space which serves as a gas passage inside the substrate. The plurality of cell stacks 5-1 to 5-n are disposed such that the upper part opens to the fuel supply header 6 and the lower part opens to the fuel discharge header 7, and are supported by the upper tube plate 2 and the lower tube plate 3.

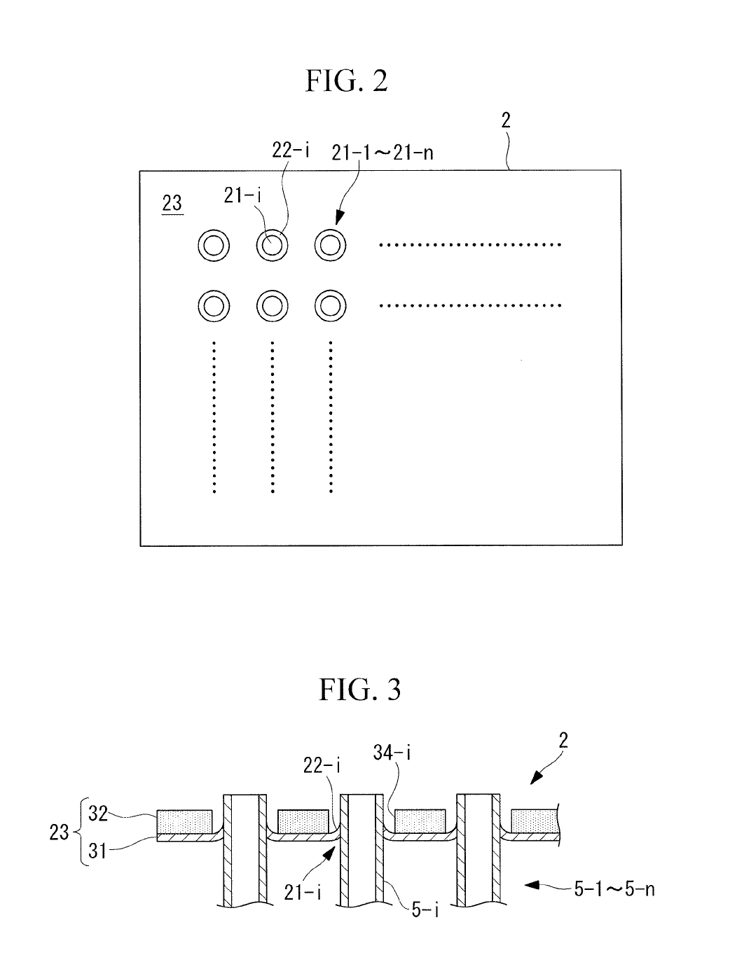

FIG. 2 is a plan view showing the tube plate, and here the upper tube plate 2 will be described as an example. A plurality of thin plate holes 21-1 to 21-n corresponding to the plurality of cell stacks 5-1 to 5-n are formed in the upper tube plate 2. FIG. 3 is a cross-sectional view showing the tube plate, and here a structure in which the upper tube plate 2 and the plurality of cell stacks 5-1 to 5-n are fixedly supported will be described as an example. As shown in FIG. 3, one arbitrary cell stack 5-i (i=1, 2, 3, . . . , n, where n is a natural number larger than one) of the plurality of cell stacks 5-1 to 5-n is fixed on the upper tube plate 2 by being inserted into a thick plate hole 34-i and a thin plate hole 21-i, corresponding to the cell stack 5-i, of a plurality of thick plate holes 34-1 to 34-n (n is a natural number larger than one) and the plurality of thin plate holes 21-1 to 21-n.

The upper tube plate 2 is formed of a plurality of thin plate portions 22-1 to 22-n that are composed only of the thin plate and a thick plate portion 23 where the thin plate and the thick plate are joined together. In the upper tube plate 2, the plurality of thin plate portions 22-1 to 22-n are formed around the plurality of thin plate holes 21-1 to 21-n. The plurality of thin plate portions 22-1 to 22-n have a plate thickness of 0.5 mm.

The thick plate portion 23 is formed in the region of the upper tube plate 2 other than the regions of the plurality of thin plate portions 22-1 to 22-n. That is, the thick plate portion 23 is formed such that a line connecting two of the plurality of thin plate portions 22-1 to 22-n always overlaps the thick plate portion 23. The thick plate portion 23 has a plate thickness of 3.0 mm.

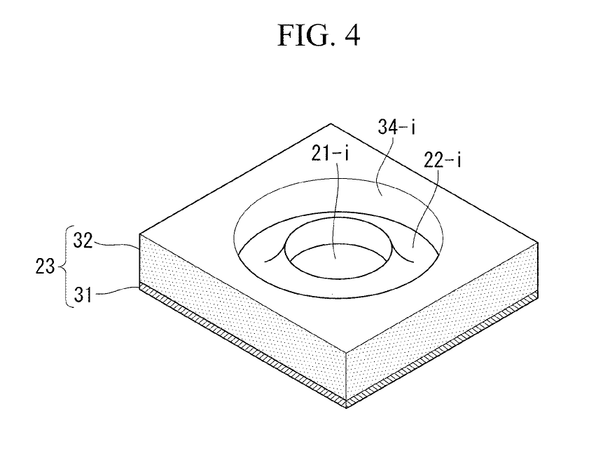

FIG. 4 shows a partially enlarged view of the structure of the upper tube plate 2 shown in FIG. 2. The upper tube plate 2 is formed of a thin plate 31 and a thick plate 32. The thin plate 31 is formed of a relatively high-strength material such as high-nickel steel represented by Hastelloy®, for example, and is formed of a plate having a plate thickness of 0.5 mm. The plurality of thin plate holes 21-1 to 21-n are formed in the thin plate 31. The thick plate 32 is formed of a material (e.g., SUS304) lower in strength than the thin plate 31, and is formed of a plate having a plate thickness of 2.5 mm. The upper tube plate 2 is produced by joining together the thin plate 31 and the thick plate 32 by means of diffusion welding. The plurality of thick plate holes 34-1 to 34-n are formed in the thick plate 32. The plurality of thick plate holes 34-1 to 34-n have a larger diameter than the thin plate hole 21-i. The plurality of thin plate holes 21-1 to 21-n formed in the thin plate 31 concentrically overlap the plurality of thick plate holes 34-1 to 34-n formed in the thick plate 32. Due to the presence of such a thick plate portion 23, deformation of the upper tube plate 2 is limited to a predetermined allowable range, and the plurality of cell stacks 5-1 to 5-n can be firmly supported.

The plate thickness of the plurality of thin plate portions 22-1 to 22-n can be substituted with a plate thickness other than 0.5 mm. Examples of the plate thickness of the plurality of thin plate portions 22-1 to 22-n can be plate thicknesses within the range from 0.2 mm to 0.7 mm. The lower limit is defined in view of the limit of plate thinning due to steam oxidation corrosion. The upper limit is defined in view of preventing cell breakage during fitting and assembly. The plate thickness of the thick plate 32 can be substituted with a plate thickness other than 2.5 mm. Examples of the plate thickness of the thick plate 32 can be plate thicknesses within the range from 2 mm to 5 mm. The upper and lower limits are determined with the rigidity required for the cartridge structure taken into account. The lower limit is defined such that the cartridge rigidity of the number of existing cells is maintained, while the upper limit is defined in view of the rigidity allowable for the cartridge size.

The lower tube plate 3 is formed in the same manner as the upper tube plate 2. That is, the lower tube plate 3 has a plate-like shape in which a plurality of thin plate holes corresponding to the plurality of cell stacks 5-1 to 5-n are formed. A thin plate portion having a plate thickness of 0.5 mm is formed around the thin plate holes. A thick plate portion having a plate thickness of 3.0 mm is formed in the region except for the regions of the plurality of thin plate portions.

In the same manner as the upper tube plate 2, the lower tube plate 3 can also be produced by joining a thin plate and a thick plate by means of diffusion welding. In the lower tube plate 3, the plurality of thin plate holes 21-1 to 21-n formed in the thin plate concentrically overlap the plurality of thick plate holes 34-1 to 34-n formed in the thick plate. The thin plate 31 and the thick plate 32 are diffusion-welded. The upper tube plate 2 and the lower tube plate 3 are joined by welding on the upper lid 1-1 and the lower lid 1-2, respectively. In the fuel cell module 10, the plurality of cell stacks 5-1 to 5-n are supported by the upper tube plate 2 and the lower tube plate 3.

In the fuel cell, a fuel gas is supplied to the fuel supply header 6 through the fuel supply pipe 11 of the fuel cell module 10, and air is supplied to the power generation chamber 8 through the air supply pipe 14. The fuel gas supplied to the fuel supply header 6 flows through the passage inside the plurality of cell stacks 5-1 to 5-n and is supplied to the fuel discharge header 7 before being discharged to the outside of the fuel cell module 10 through the fuel discharge pipe 12. The air supplied to the power generation chamber 8 is used for power generation by the fuel cell cells formed in the plurality of cell stacks 5-1 to 5-n, and is thereafter discharged to the outside of the fuel cell module 10 through the air discharge pipe 15.

The fuel supply header 6, the fuel discharge header 7, and the power generation chamber 8 are disposed adjacently while retaining airtightness through the upper tube plate 2 or the lower tube plate 3 such that the gases flowing through the respective spaces are not mixed.

For example, the contact portions between the plurality of cell stacks 5-1 to 5-n and the plurality of thin plate portions 22-1 to 22-n are equipped with a seal structure to maintain the airtightness.

In the following, one example of the seal structure will be described. This structure includes a seal layer interposed between the cell stack and the thin plate, a first ring interposed between the seal layer and the thin plate, and a second ring that constitutes a part of the thin plate and is interposed between the first ring and the thin plate. The seal layer has a property of adhering to the cell stack and the first ring. The second ring has a surface smoothly curved in the direction of the center line of the cell stack. The curved surface is in surface contact or linear contact under pressure with the first ring. The curved surface is formed by bending the thin plate.

As the fuel gas flows through the inside of the cell stacks and the air flows through the power generation chamber 8, the plurality of cell stacks 5-1 to 5-n generate power by causing an electrochemical reaction between the fuel gas and the air.

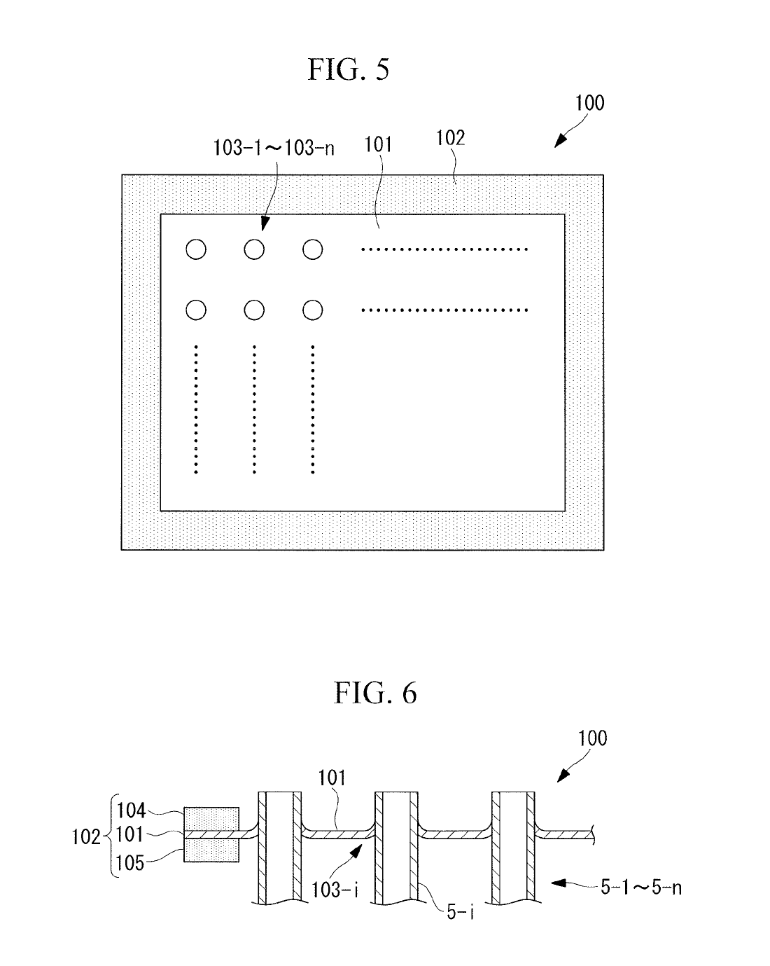

According to the tube plate of the present invention, since the thick plate portion 23 having a larger plate thickness is formed between the plurality of thin plate holes 21-1 to 21-n, the upper tube plate 2 or the lower tube plate 3 is higher in strength than the upper tube plate 100 of the conventional example shown in FIGS. 5 and 6. Therefore, the upper tube plate 2 or the lower tube plate 3 can maintain the supporting strength even when an increased number of the plurality of cell stacks 5-1 to 5-n to be supported is integrated. Thus, a fuel cell including the fuel cell module 10 can increase the power generation amount relative to the installation area and installed capacity by integrating a larger number of cell stacks, and can be made compact in size.

The fuel cell module 10 can require replacement of cell stacks, for example, when a defect is found in part of the cell stacks. In such a case, the welded parts between the upper lid 1-1 and the upper tube plate 2 and between the lower lid 1-2 and the lower tube plate 3 are removed and the cell stacks are replaced, and then the upper lid 1-1 and the upper tube plate 2 and the lower lid 1-2 and the lower tube plate 3 are joined again. In the upper tube plate 100 of the conventional example, of which only the side edges are joined by welding, after multiple times of re-welding, the portions of the side edges joined by welding are likely to peel off and difficult to repair, and the state before maintenance cannot be restored. In the present invention, since the upper tube plate 2 and the lower tube plate 3 have the thin plate 31 and the thick plate 32 diffusion-welded, even when the upper lid 1-1 and the lower lid 1-2 are removed and re-welded multiple times, the thin plate 31 and the thick plate 32 are less likely to peel off due to welding heat. Therefore, compared with the upper tube plate 100 of the conventional example that is joined by welding only on the side edges, the fuel cell module 10 can be restored to the state before maintenance even after maintenance.

The thick plate 32 of the upper tube plate 2 can also be formed, for example, of the high-nickel steel that forms the thin plate 31. Also in this case, since the thick plate portion is formed in the upper tube plate 2, it can firmly support the plurality of cell stacks 5-1 to 5-n on the upper lid 1-1. In addition, a material such as SUS304 is generally available at lower prices than high-nickel steel. Therefore, since the fuel cell module 10 has the thick plate 32 of the upper tube plate 2 formed of SUS304, for example, it can be produced at lower cost compared with the fuel cell module having the thick plate 32 formed of high-nickel steel.

The lower tube plate 3 may have the same composition as that of the upper tube plate 2, and also in this case, the lower tube plate 3 can firmly support the plurality of cell stacks 5-1 to 5-n on the lower lid 1-2.

The thin plate 31 and the thick plate 32 can also be formed from other materials than SUS304 and high-nickel steel if the upper tube plate 2 can properly support the plurality of cell stacks 5-1 to 5-n, namely, if the upper tube plate 2 is formed so as to have predetermined attributes (strength, bending rigidity, heat resistance, e.g., yield stress of 250 MPa or higher at 550° C., and thermal expansion coefficient of approx. 7 to 15×10⁻⁶ mm/mm). Also in this case, since the thick plate portion is formed in the upper tube plate, it can firmly support the plurality of cell stacks 5-1 to 5-n on the upper lid 1-1.

The lower tube plate 3 may have the same composition as that of the upper tube plate 2, and also in this case, the lower tube plate 3 can firmly support the plurality of cell stacks 5-1 to 5-n on the lower lid 1-2.

The upper tube plate 2 and the lower tube plate 3 can be substituted with other tube plates that are formed by other methods than welding. Examples of such tube plates can be those with a thick plate portion and a thin plate portion formed by cutting. In the modified example shown in FIG. 21, in the upper tube plate 2, the thick plate portion 23 and the thin plate portions 22-1 to 22-n are integrally formed by cutting. Since the thick plate portion is formed, such tube plates can also support the plurality of cell stacks 5-1 to 5-n firmly on the upper lid 1-1 and the lower lid 1-2.

### Second Embodiment

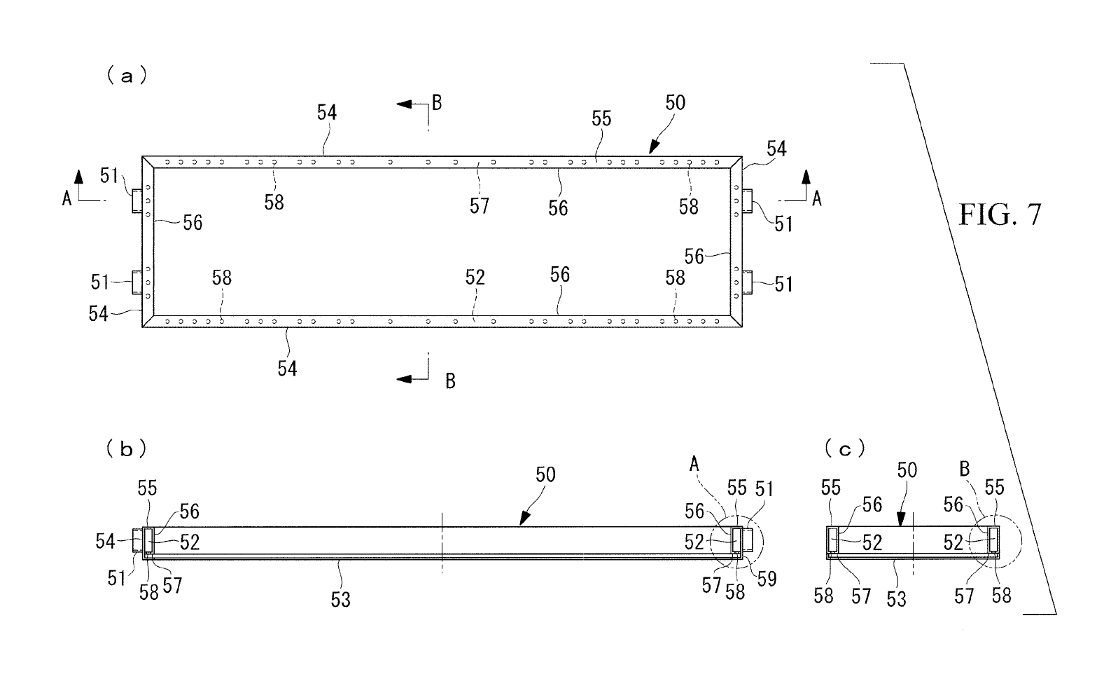

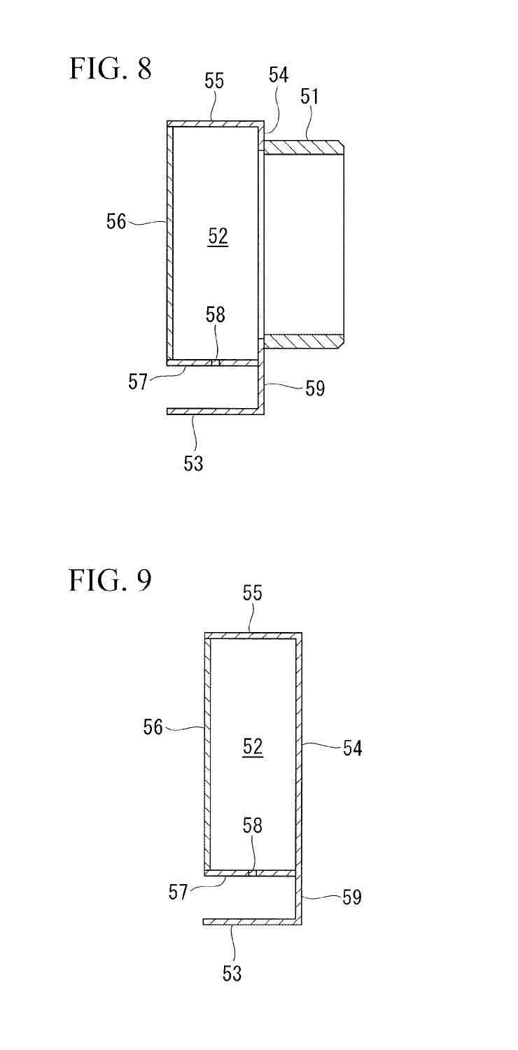

In the following, an air supply header 50 of a fuel cell module and a method for supplying air to a fuel cell module according to a second embodiment of the present invention will be described with reference to FIG. 7 to FIG. 11. In the following description, air will be taken as one example of the oxidant supplied to the fuel cell module, but other oxidants may be used for the present invention. The fuel cell module according to the second embodiment may be implemented with the above-described first embodiment or may be implemented separately from the first embodiment.

As shown in FIG. 7, the air supply header 50 of the fuel cell module according to this embodiment (hereinafter called the air supply header 50) is provided with an air duct 52 having a frame shape formed by a rectangular pipe. Air supply pipes 51 are provided so as to be coupled on an outer surface 54 of the air duct 52, and air is supplied to the air duct 52 through the air supply pipes 51. The air duct 52 is formed into a frame shape by forming, for example, a quadrangular frame shape with the rectangular pipe.

The air supply header 50 has the air duct 52, and an extension part 59 of the outer surface 54 of the rectangular duct, which constitutes the air duct 52, extending downward at least beyond a lower surface 57. The end of the extension part 59 in the outer surface 54 is connected with a partition surface 53 provided in parallel with the lower surface 57. The partition surface 53 has a frame shape of four long plate members combined, and the width of each long plate member is almost equal to the length of the lower surface 57 extending to the inner side from the outer surface 54.

In this embodiment, two air supply pipes 51 are connected on each of the pair of outer surfaces 54 located on the short sides of the air supply header 50.

The air duct 52 is a space with a hollow inside formed by the rectangular pipe, and is formed (defined) by the outer surface 54, an upper surface 55, an inner surface 56, and the lower surface 57.

The outer end (outer peripheral end) of the lower surface 57 is connected on the outer surface 54 below the middle point in the height direction of the outer surface 54 such that a constant (predetermined) clearance is formed between the lower surface 57 and the partition surface 53.

As shown in FIG. 7(a), the lower surface 57 is provided with holes 58, which penetrate in the plate thickness direction, so as to be concentrated at the four corners of the air supply header 50 and less concentrated toward the center in the longitudinal direction of the air supply header 50.

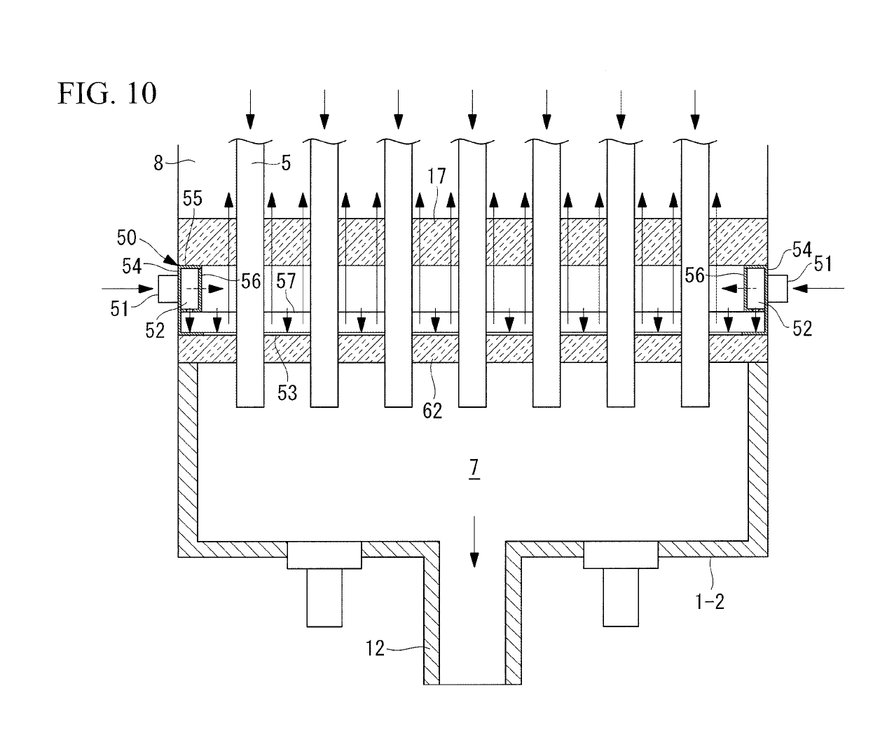

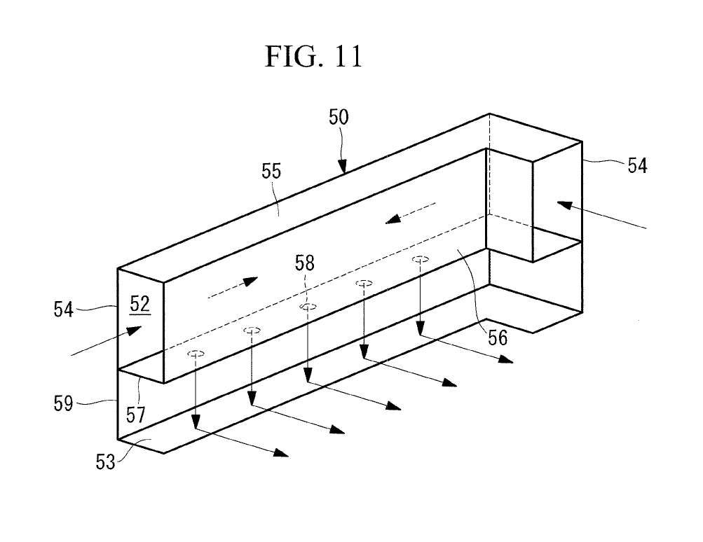

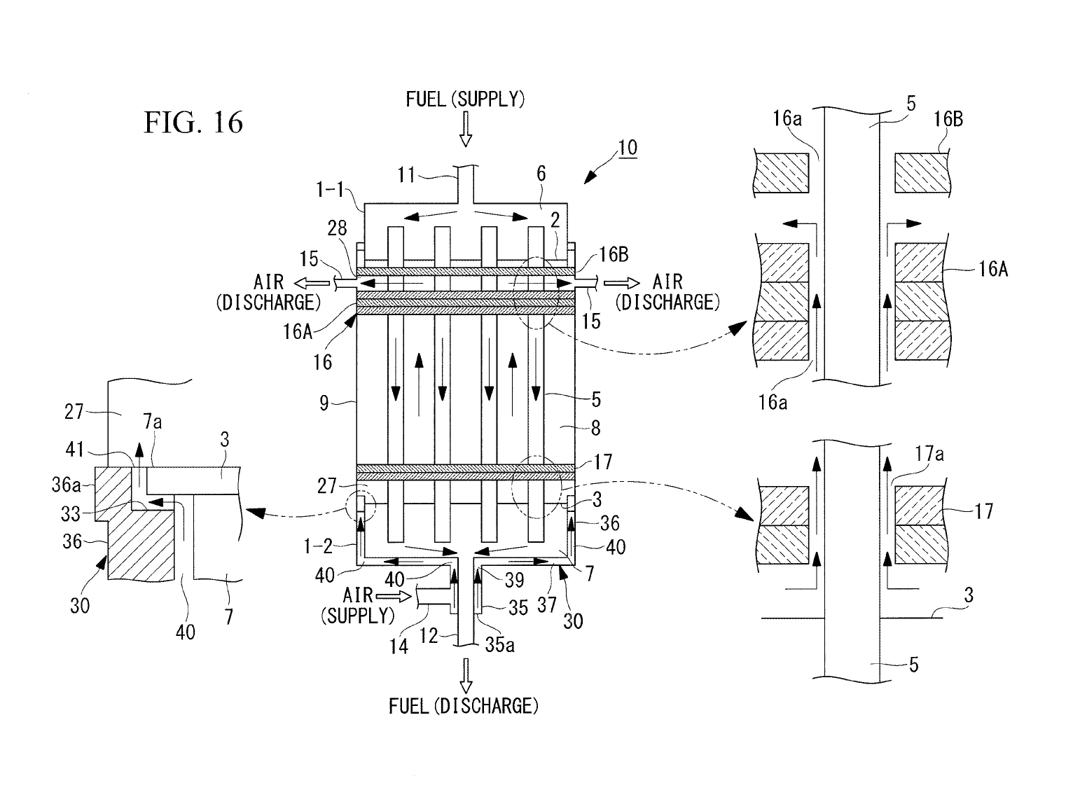

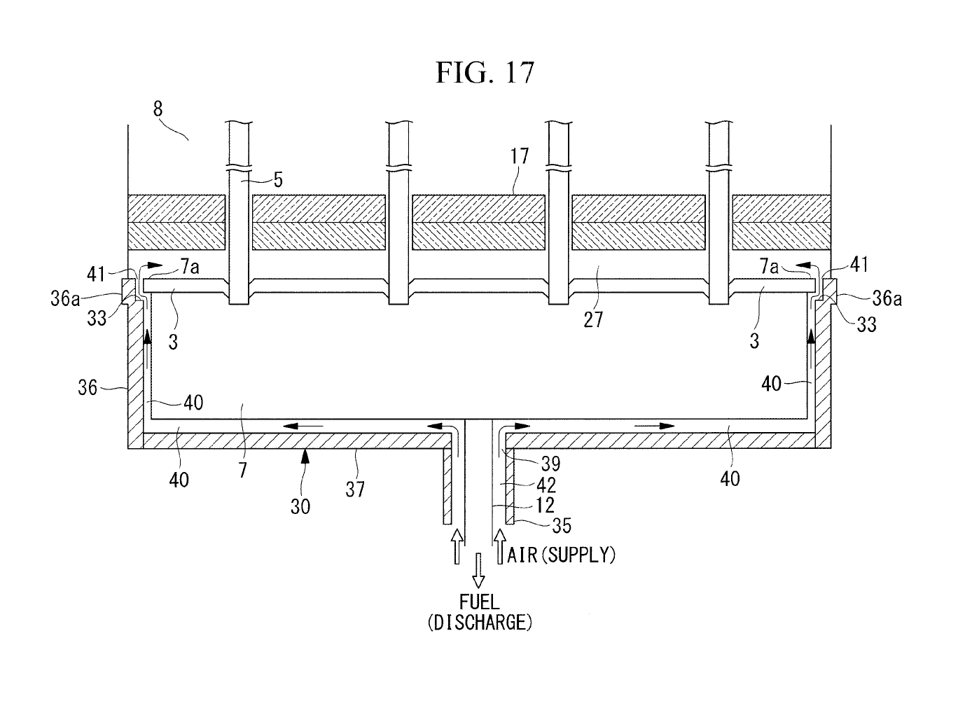

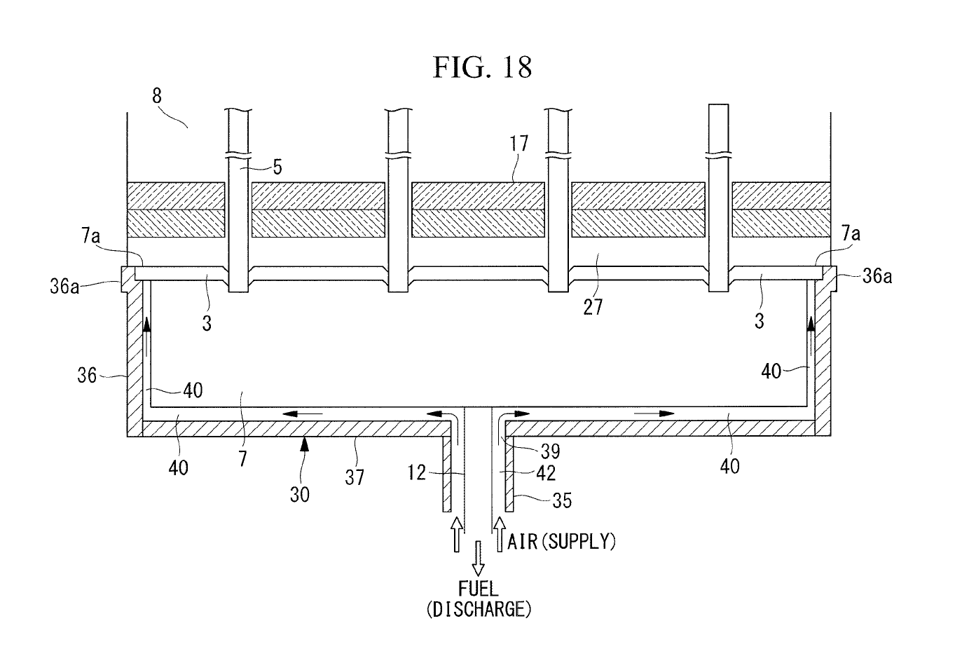

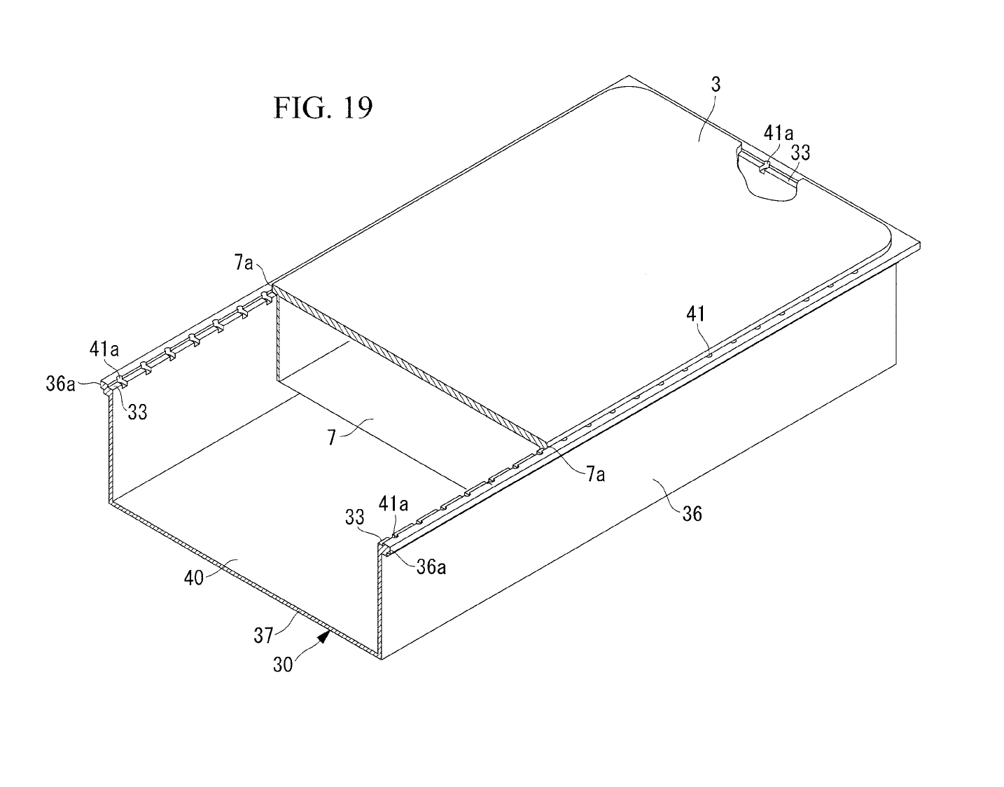

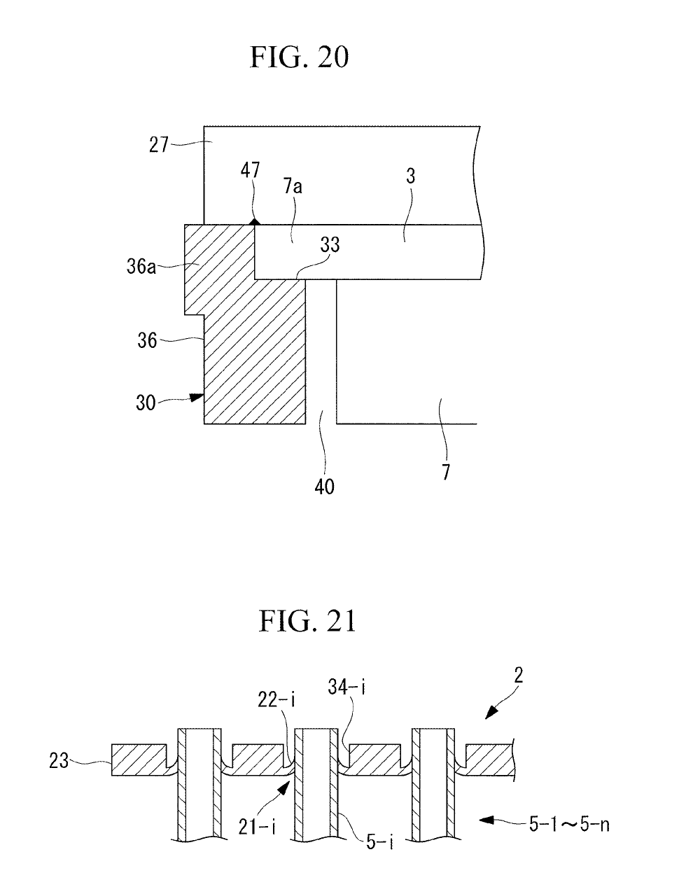

As shown in FIG. 10 or FIG. 11, the air flowing from the air supply pipes 51 into the air duct 52 is blown out from the holes 58 downward, namely, toward the partition surface 53, and after colliding against the partition surface 53, flows toward the inner side (inside) of the air supply header 50, namely, toward the space surrounded by the inner surface 56 of the air duct 52, and flows into the power generation chamber 8 through the gap between the cell stacks 5 and the holes 17a (see FIG. 16).

The reference sign 7 in FIG. 10 denotes the fuel discharge header, and the reference sign 62 denotes a heat insulating material.

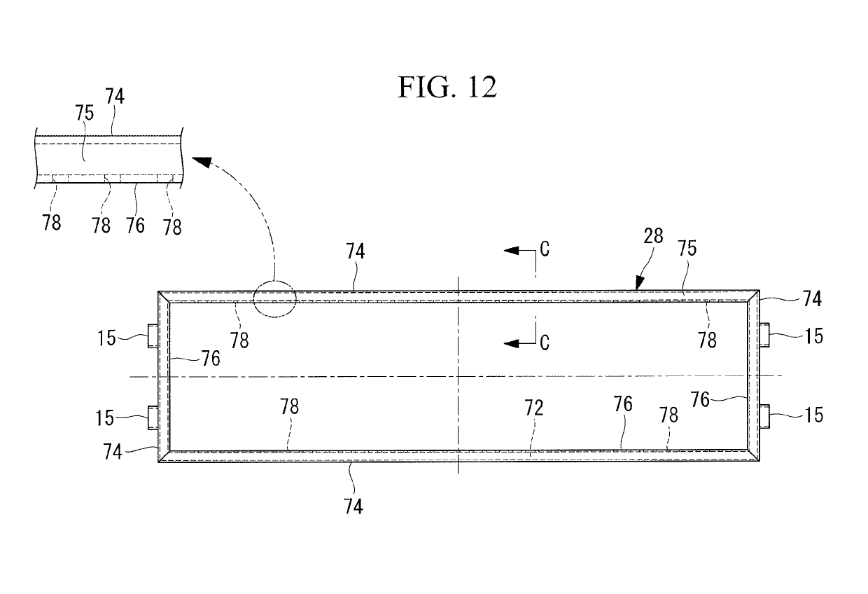

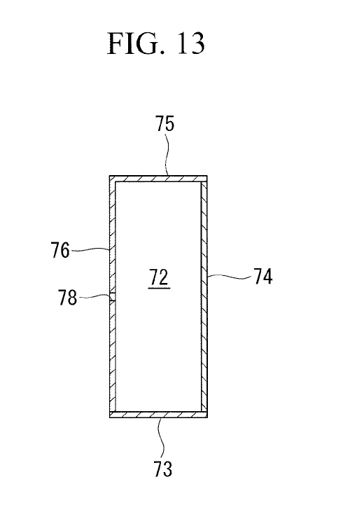

Here, the air discharge header 28 of the fuel cell module according to this embodiment and the air discharge header 28 of the fuel cell module that has been described using FIG. 16 will be described with reference to FIG. 12 and FIG. 13.

As shown in FIG. 12, similarly to the air supply header 50, the air discharge header 28 is a member having a rectangular parallelepiped shape, and the peripheral edges of the air discharge header 28 is provided with one air duct 72, which communicates with four air discharge pipes 15, continuously along the entire periphery.

The air discharge header 28 includes one partition surface 73 having a rectangular shape in a plan view, and side plates 74 provided upright on the four sides (peripheral edges) of the partition surface 73.

As shown in FIG. 13, the air duct 72 is a space of a rectangular shape in cross-section, and is formed (defined) by a top plate 75, which extends from the upper end of the side plate 74 toward the inner side (inside) in parallel with the partition surface 73, and a side plate 76, which extends from the inner end (inner peripheral end) of the top plate 75 in parallel with the side plate 74 and has the lower end connected on the partition surface 73.

As shown in FIG. 12, the side plate 76 is provided with many holes 78, which penetrate in the plate thickness direction, at a constant (predetermined) pitch on the pair of long sides facing each other.

The air flowing from the air discharge header 28 through the holes 78 into the air duct 72 flows toward the nearest air discharge pipe 15, and is discharged from the nearest air discharge pipe 15.

According to this embodiment, the peripheral edges of the partition surface 53 is provided with the one air duct 52 that is provided continuously along the entire periphery and communicates with the air supply pipes 51 connected on the side plate 54, and the space formed inside the air duct 52 and the air duct 52 communicate with each other through the plurality of holes 58.

Since the pressure loss of the air is determined by the shape (diameter) of the holes 58 formed in the air duct 52, the air can be uniformly supplied to the space surrounded by the inner surface of the air duct 52.

The air blown out from the holes 58 collides against the partition surface 53 and then flows toward the space formed inside the air duct 52. That is, after being diffused in all directions on colliding against the partition surface 53, the air flows toward the space formed inside the air duct 52.

In this way, the air supplied into the power generation chamber 8 through the plurality of holes 58 can be uniformized in the circumferential direction. As a result, the temperature and the power generation performance of the power generation chamber 8 can be stabilized.

Moreover, since the air supply pipes 51 are connected on the outer surface of the air duct 52, unlike the conventional example, the fuel cell module has no double structure. Therefore, the penetration structure of the current collector rod and the fuel discharge pipe is eliminated and the welding work is not required. As a result, degradation of airtightness due to poor welding can be avoided.

According to this embodiment, since the holes 58 are provided so as to be concentrated at the four corners and less concentrated toward the center in the longitudinal direction, the uniformization in the circumferential direction of the air supplied into the power generation chamber 8 through the plurality of holes 58 can be optimized, and the oxygen distribution inside the header 50 can be uniformized. The arrangement and the diameter of the holes 58 are determined, for example, by conducting flow analysis such that the air distribution inside the air supply header 50 during operation can be most uniformized.

According to a fuel cell module equipped with the air supply header 50 of this embodiment, since it is equipped with the air supply header 50 that can uniformize the air supplied into the power generation chamber 8 through the plurality of holes 58 in the circumferential direction, the power generation performance and the reliability of the fuel cell can be improved.

According to a fuel cell module equipped with the air supply header 50 of this embodiment, since it has no double-box structure under the power generation chamber for housing the fuel discharge header inside the support stand as in the conventional example, it is possible to provide the heat insulating material 62 between the air supply header 50 and the fuel discharge header 61. Therefore, the heat-retaining property of the power generation chamber 8 can be further improved, and the power generation performance and the reliability of the fuel cell can be further improved.

### Third Embodiment

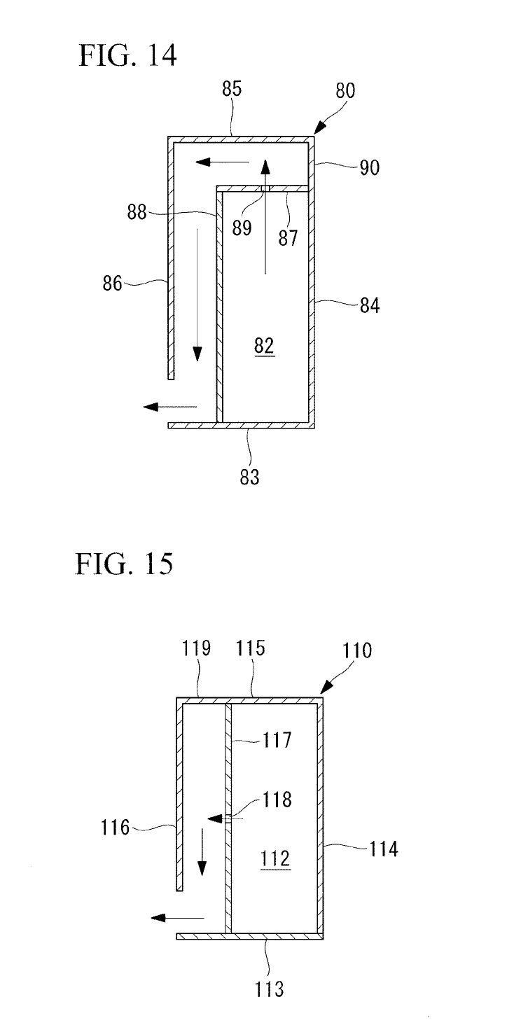

An air supply header 80 and a method for supplying air to a fuel cell module according to a third embodiment of the present invention will be described with reference to FIG. 14. In the following description, air will be taken as one example of the oxidant supplied to the fuel cell module, but other oxidants may be used for the present invention. The fuel cell module according to the third embodiment may be implemented with the above-described first embodiment or may be implemented separately from the first embodiment.

Similarly to the above-described air supply header 50, the air supply header 80 according to this embodiment is provided with an air duct 82 having a frame shape formed by a rectangular pipe. The air supply pipes 51 are provided so as to be coupled on an outer surface 84 of the air duct 82, and air is supplied to the air duct 82 through the air supply pipes 51. The air duct 82 is formed into a frame shape by forming a quadrangular frame shape with the rectangular pipe.

The air supply header 80 has an air duct 82, and an extension part 90 of the outer surface 84 of the rectangular pipe, which constitutes the air duct 82, extending upward at least beyond an upper surface 87. The end of the extension part 90 in the outer surface 84 is connected with a partition surface 85 provided in parallel with the upper surface 87.

The upper surface 87 extends to the outer side (outside) in parallel with the partition surface 85 from the upper end of an inner surface 88. The outer end (outer peripheral end) of the upper surface 87 is connected on the outer surface 84 above the middle point in the height direction of the outer surface 84 such that a constant (predetermined) clearance is formed between the upper surface 87 and the partition surface 85.

The inner surface 88 extends to the lower side (downward) in parallel with the outer surface 84 from the inner end (inner peripheral end) of the upper surface 87, and the lower end of the inner surface 88 is connected on the lower surface 83.

The inner end (inner peripheral end) of the partition surface 85 is positioned on the inner side (inside) of the inner end (inner peripheral end) of the upper surface 87 such that a constant (predetermined) clearance is formed between the side surface 86 and the inner surface 88, the upper surface 87 is positioned on the lower side (downside) of the partition surface 85 such that a constant (predetermined) clearance is formed between the upper surface 87 and the partition surface 85, and the lower end of the side surface 86 is positioned on the upper side (upside) of the lower surface 83 such that a constant (predetermined) clearance is formed between the lower end and the lower surface 83.

The air duct 82 is a space with a hollow inside formed by a rectangular pipe, and is formed (defined) by the lower surface 83, the outer surface 84, the upper surface 87, and the inner surface 88.

An air passage is formed by the clearance formed between the partition surface 85 and the upper surface 87, the clearance formed between the side surface 86 and the inner surface 88, and the clearance formed between the lower end of the side surface 86 and the lower surface 83.

The upper surface 87 is provide with holes 89, which penetrate in the plate thickness direction, so as to be concentrated at the four corners of the air supply header 80 and less concentrated toward the center in the longitudinal direction of the air supply header 80, as with the holes shown in FIG. 7(a).

As shown in FIG. 14, the air flowing from the air supply pipes 51 to the air duct 82 is blown out from the holes 89 upward, namely, toward the partition surface 85, and after colliding against the partition surface 85, flows toward the inner side (inside) of the air supply header 80. The air flowing toward the inner side (inside) of the air supply header 80 collides against the side surface 86 and then flows toward the lower side (downside) of the air supply header 80. The air flowing toward the lower side (downside) of the air supply header 80 collides against the lower surface 83 and then flows to the inner side (inside) of the air supply header 80 and flows into the power generation chamber 8 through the gap between the cell stacks 5 and the holes 17a (see FIG. 16).

The advantages of the air supply header 80 and the method for supplying air to a fuel cell module according to this embodiment are the same as those of the second embodiment, and therefore will not be described here.

### Fourth Embodiment

An air supply header 110 and a method for supplying air to a fuel cell module according to a fourth embodiment of the present invention will be described with reference to FIG. 15. In the following description, air will be taken as one example of the oxidant supplied to the fuel cell module, but other oxidants may be used for the present invention. The fuel cell module according to the fourth embodiment may be implemented with the above-described first embodiment or may be implemented separately from the first embodiment.

Similarly to the above-described air supply headers 50, 80, the air supply header 110 according to this embodiment is provided with an air duct 112 having a frame shape formed by a rectangular pipe. The air supply pipes 51 are provided so as to be coupled on an outer surface 114 of the air duct 112, and air is supplied to the air duct 112 through the air supply pipes 51. The air duct 112 is formed into a frame shape by forming a quadrangular frame with the rectangular pipe.

The air supply header 110 has the air duct 112, and an extension part 119 of an upper surface 115 of the rectangular pipe, which constitutes the air duct 112, extending inward at least beyond the inner surface 117. The end of the extension part 119 in the upper surface 115 is connected on a partition surface 116 provided in parallel with the inner surface 117.

The inner end (inner peripheral end) of the upper surface 115 is positioned on the inner side (inside) of the inner end (inner peripheral end) of the inner surface 117 such that a constant (predetermined) clearance is formed between the partition surface 116 and the inner surface 117, and the lower end of the partition surface 116 is positioned on the upper side (upside) of the lower surface 113 such that a constant (predetermined) clearance is formed between the lower end and the lower surface 113.

The upper end of the inner surface 117 is connected on the upper surface 115 on the inner side (inside) of the middle point in the width direction of the upper surface 115 such that a constant (predetermined) clearance is formed between the partition surface 116 and the inner surface 117, and the lower end of the inner surface 117 is connected on the lower surface 113.

The air duct 112 is a space with a hollow inside formed by the rectangular pipe, and is formed (defined) by the lower surface 113, the outer surface 114, the upper surface 115, and the inner surface 117.

An air passage is formed by the clearance formed between the partition surface 116 and the inner surface 117 and the clearance formed between the lower end of the partition surface 116 and the lower surface 113.

The inner surface 117 is provide with holes 118, which penetrate in the plate thickness direction, so as to be concentrated at the four corners of the air supply header 110 and less concentrated toward the center in the longitudinal direction of the air supply header 110, as with the holes shown in FIG. 7(a).

As shown in FIG. 15, the air flowing from the air supply pipes 51 to the air duct 112 is blown out from the holes 118 inward, namely, toward the partition surface 116, and after colliding against the partition surface 116, flows toward the lower side (downside) of the air supply header 110. The air flowing toward the lower side (downside) of the air supply header 110 collides against the lower surface 113 and then flows toward the inner side (inside) of the air supply header 110 and flows into the power generation chamber 8 through the gap between the cell stacks 5 and the holes 17a (see FIG. 16).

The advantages of the air supply header 110 and the method for supplying air to a fuel cell module according to this embodiment are the same as those of the above-described second embodiment, and therefore will not be described here.

The present invention is not limited to the above-described embodiments, but can be implemented with modifications and changes appropriately made to these embodiments.

### REFERENCE SIGNS LIST

1-1 Upper lid

1-2 Lower lid

2 Upper tube plate

3 Lower tube plate

5 Cell stack

5-1 to 5-n Plurality of cell stacks

6 Fuel supply header

7 Fuel discharge header

8 Power generation chamber

10 Fuel cell module

11 Fuel supply pipe

12 Fuel discharge pipe

14, 51 Air supply pipe (oxidant supply pipe)

15 Air discharge pipe

21-1 to 21-n Plurality of thin plate holes

22-1 to 22-n Plurality of thin plate portions

23 Thick plate portion

27, 50, 80, 110 Air supply header (oxidant supply header)

28 Air discharge header

31 Thin plate

32 Thick plate

34-1 to 34-n Plurality of thick plate holes

52, 82, 112 Air duct (oxidant duct)

53, 83, 113 Partition surface

54, 84, 114 Outer surface

58, 89, 118 hole

62 Heat insulating material

1. A fuel cell module comprising:
a plurality of cell stacks that generate power by causing an electrochemical reaction between a fuel gas and an oxidant gas; and
a tube plate supporting the plurality of cell stacks, wherein
the tube plate is composed of thin plate portions and a thick plate portion,
a plurality of thick plate holes, which are blind holes where the thin plate portions are remained, are formed in the thick plate portion, and a plurality of thin plate holes, through which the cell stacks penetrate, which are sealed so as to secure airtightness and which have a smaller diameter than the thick plate holes, are formed in the thin plate portions which are respectively remained in the thick plate holes, and
the plate thickness of the thick plate portion is larger than the plate thickness of the plurality of thin plate portions.

2. The fuel cell module according to claim 1, wherein
the tube plate is formed by joining together a thin plate and a thick plate,
the plurality of thin plate portions are formed of the thin plate, and
the thick plate portion is formed of the thin plate and the thick plate.

3. The fuel cell module according to claim 2, wherein the material forming the thin plate is a metal material of which the difference in thermal expansion coefficient from the material forming the thick plate is within a predetermined range and which is different in material properties from the material forming the thick plate.

4. A fuel cell equipped with the fuel cell module according to claim 1.

5. A manufacturing method of the fuel cell module according to claim 2, including:
producing the tube plate by joining together the thin plate and the thick plate by means of diffusion welding, and
supporting the plurality of cell stacks using the tube plate.

6. The fuel cell module according to claim 1, comprising an oxidant supply header including:
an oxidant duct having a frame structure;
an oxidant supply pipe that is connected on the outer surface of the oxidant duct and supplies an oxidant to the oxidant duct;
a plurality of holes that are formed in the oxidant duct and communicate with a space surrounded by the inner surface of the oxidant duct; and
a partition surface installed opposite to the surface of the oxidant duct in which the holes are formed.

7. The fuel cell module according to claim 6, wherein the holes are provided so as to be concentrated at four corners of the oxidant duct, the oxidant duct being rectangular, and less concentrated toward the center in the long-side direction of the oxidant duct.

8. A fuel cell equipped with the fuel cell module according to claim 6.

9. The fuel cell according to claim 8, wherein a heat insulating material is provided between the oxidant supply header and a fuel discharge header positioned under the oxidant supply header.

10. A method for supplying an oxidant to a fuel cell module, the fuel cell module comprising: an oxidant duct having a frame structure; an oxidant supply pipe that is connected on the outer surface of the oxidant duct and supplies an oxidant to the oxidant duct; a plurality of holes that are formed in the oxidant duct and communicate with a space surrounded by the inner surface of the oxidant duct; and a partition surface installed opposite to the surface of the oxidant duct in which the holes are formed, wherein
the oxidant blown out from the holes collides against the partition surface and then flows toward the space surrounded by the inner surface of the oxidant duct.
